(19) United States
(12) Patent Application Publication
(10) Pub. No.: US 2002/0078836 A1
(43) Pub. Date: Jun. 27, 2002

(54) Alternative stamp die device

(76) Inventors: John A. Goyette, Attleboro, MA (US); Joel A. Allegrezza, Uxbridge, MA (US); Charles D. Battersby, Sturbridge, MA (US); Christopher M. Sullivan, Rochester, MA (US)

Correspondence Address: TEXAS INSTRUMENTS INCORPORATED, P O BOX 655474, M/S 3999, DALLAS, TX, 75265

(21) Appl. No.: 10/001,603

(22) Filed: Oct. 25, 2001

Related U.S. Application Data
(60) Provisional application No. 60/257,838, filed on Dec. 21, 2000.

(51) Int. Cl. B31F 1/07; B44B 5/00

(52) U.S. Cl. 101/16

(57) ABSTRACT

An alternative stamp die is designed with tapered areas and non-tapered areas to provide for a longer lived stamp die while avoiding the problems associated with slug pulling.

### BACKGROUND OF THE INVENTION

In the art of stamp press dies, power press tools are used for forming a predefined shaped part, called a leadframe, by punching the leadframe from a sheet or strip of material. FIG. 1 shows an elevation view of a typical stamp tool 101. Here a punch 102, which can be made of carbide, punches through a strip of material 103. The punch 102 can be held within a punch holder 104 which in turn can be held by a punch shoe 105 and driven by a ram 106. A stripper 107 can be provided to hold the material 103 and to guide the punch 102 during punching, also known as blanking. A die shoe 108 is provided for supporting the strip material 103 and for holding at least one stamp press die 109. The stamp press die 109 has an aperture 111 with an edge against which the strip material 103 is pressed by the punch 102. As the punch 102 presses the material 103, a leadframe or slug 110 is formed by being cut by the stamp press die 109, and pressed through the aperture 111 of the stamp press die 109.

FIG. 2 shows a press cycle for a typical stamp tool 101. In FIG. 2a, the punch 102 is loaded above the strip material 103 as the strip material 103 is fed into position between the stripper 107 and the stamp press die 109. In FIG. 2a, the punch 102 forces itself through the strip material 103 thereby removing a section of the material 103. This section is referred to as a slug 110. As shown in FIG. 3a, upon achieving the ultimate tensile strength of the strip material 103, the slug 110 is then forced into the die 109, which is the mating component of the punch 102. The edges of the die cavity effectively cut the sheet material 103 into the slug 110 and the shape of the slug 110 conforms closely to the shape of the die cavity. The punch 102 is then retracted from the die 109 and material 103 during the upwards cycle of the press stroke, leaving the stamped out slug 110 contained within the die 109. After the punch stroke, the punch 102 returns to the loaded position, as shown in FIG. 2a, and the process can begin again.

In a typical process, a stamping press can power the tool 101 in vertical strokes at rates of 500 strokes per minute, while metal strip material 103 is fed through the tool 101. At each stroke of the press, hundreds of carbide punches pierce the metal strip. Slugs 110 are extracted similar in geometry to the punch 102 and are pushed into the die 109. After each cycle, one slug 110 after another is pushed into the die 109. Because the shape of each slug 110 conforms closely with the shape of the die cavity, after a number of slugs 110 have been pushed into the die 109 these slugs 110 can become jammed in the die 109. This condition, called packing, prevents further slugs 110 from being pushed into the die 109.

In order to overcome the problems of packing, conventional dies are tapered as shown in FIG. 3. Tapers facilitate the passage of slugs 110 through the die 109 during the blanking process. Tapering provides a subtle widening of the die cavity 301 from the cutting aperture 302 of the die 109 to the exit aperture 303 of the die 109. Conventional dies 109 use uniform tapers of approximately 0.1° from the cutting aperture 302 to the exit aperture 303 and are provided around the perimeter of the die cavity. Thus, as additional slugs 110 are pushed into the die, the lateral forces against the side of each slug 110 decrease in the direction of the widening taper. As a result, slugs 110 pushed through the die 109 are free to fall out the exit aperture 303.

Standard dies are provided with a uniform taper around the die cavity 301. During normal maintenance, the cutting aperture 302 of the die 109 is periodically sharpened through surface grinding in order to maintain a sharp edge along the cutting side of the die 109. Removal of die material, while required to maintain die sharpness, increases the size of the cutting aperture 302 of the die 109 due to the taper. As a result, the tool is more inclined to slug pulling due to reduction in the lateral forces that retain the slug 110 within the die 109. After a number of maintenance treatments, the die 109 may fail to retain the slug 110 with the undesirable consequence of the slug 110 following the punch 102 on extraction.

When slug pulling occurs, the loose slug 110 is free to damage the leadframe during subsequent cycling of the press and tool 101 thereby creating excessive downtime, yield loss and adding costs to the operation. The slug 110 can be pulled from the die 109 and deposited onto or under the strip material 103. Subsequent stroking of the tool with the dislodged slug produces severe damage to the stamp stripper 107. Slug pulling is an industry wide problem and efforts to overcome slug pulling have limited success. One such approach is honing, which includes sharpening of the die to provide a controlled chamfer of the edge of the die, and is a very time consuming process. However, in some cases the only remedy is the premature replacement of the die 109 component of the press tool 101.

### SUMMARY OF THE INVENTION

Accordingly, a need has arisen in the art for an alternative stamp die which reduces slug pulling and has a longer operational life than those stamp dies known before can provide.

It is an object of the invention to provide a cost effective stamp die which has prolonged tool life. It is a further object to provide a stamp die which provides greater process consistency by providing the same slug retention characteristics throughout the tool life of the stamp die. It is a further object of the invention to provide a stamp die with the capability to be installed into existing press tools.

In accordance with the present invention, a stamp die is provided having a cutting edge side with a cutting edge which defines a cutting aperture on the cutting edge side of the die, and an exit side having an exit aperture. A tapered area is provided extending from a tapered portion of the cutting edge to a corresponding tapered portion of the exit side such that the size of the corresponding portion of the cutting aperture is less than that of the exit aperture. A non-tapered area is also provided extending from a non-tapered portion of the cutting edge to a non-tapered portion of the exit side such that the size of a non-tapered portion of the cutting aperture remains the same as the size of a corresponding non-tapered portion of exit aperture.

The stamp die can provide either a partial aperture, which when joined with a similar stamp die forms a complete aperture, or the stamp die can be provided with a complete aperture such that whereby the cutting aperture and the exit aperture cooperate to form a cavity.

The stamp die can be further provided with a non-tapered area and a tapered area disposed on one side of one cutting edge such that one cutting edge of the die has a tapered portion and a non-tapered portion. It is further provided that the size of the tapered portion of the cutting edge can be greater than the size of the non-tapered portion. The stamp die further provides that the cutting aperture can forms substantially a circle or a quadrilateral.

Other technical advantages of the present invention will be readily apparent to one skilled in the art from the following figures, descriptions, and claims.

### BRIEF DESCRIPTION OF THE DRAWINGS

For a more complete understanding of the present invention and its advantages thereof, reference is now made to the following description taken in conjunction with the accompanying drawing, wherein like reference numerals represent like parts, in which:

FIG. 1 is an elevation view of a cross-section of a typical stamp die tool;

FIG. 2 is a simplified elevation diagram showing a cycle process for the typical stamp die tool of FIG. 1;

FIG. 3 is an elevation view of a cross-section a typical stamp die;

FIG. 4 is an elevation view of an alternative stamp die according to the invention;

FIG. 5 is an elevation view of an alternative stamp die according to the invention; and

FIG. 6 is an elevation view of an alternative stamp die according to the invention.

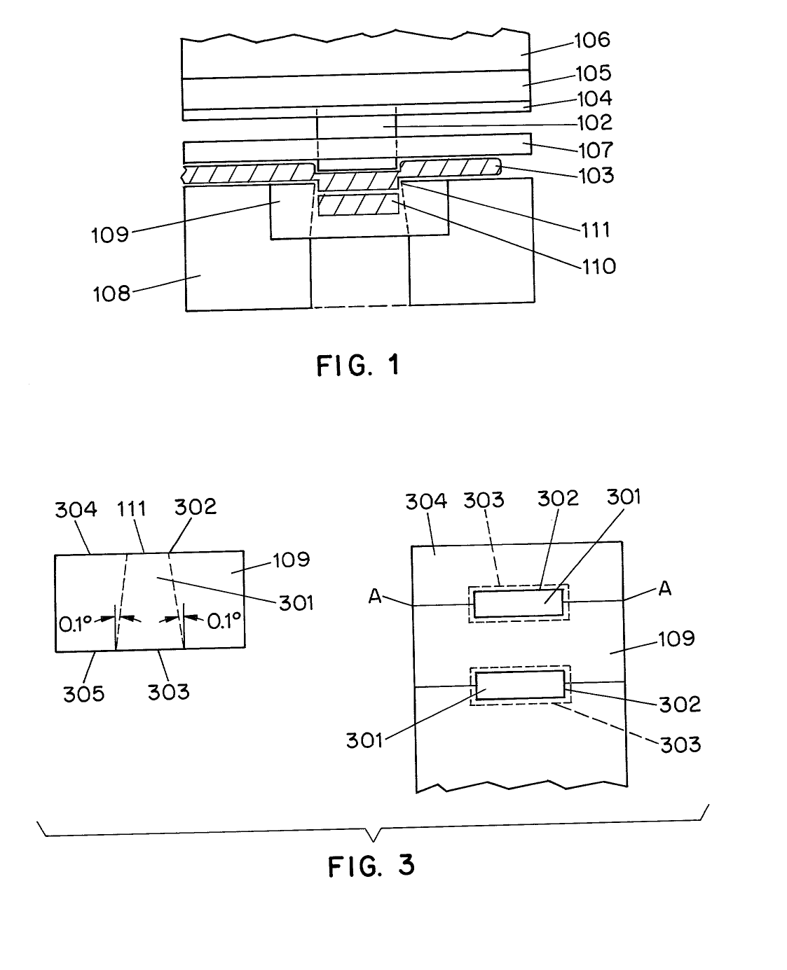

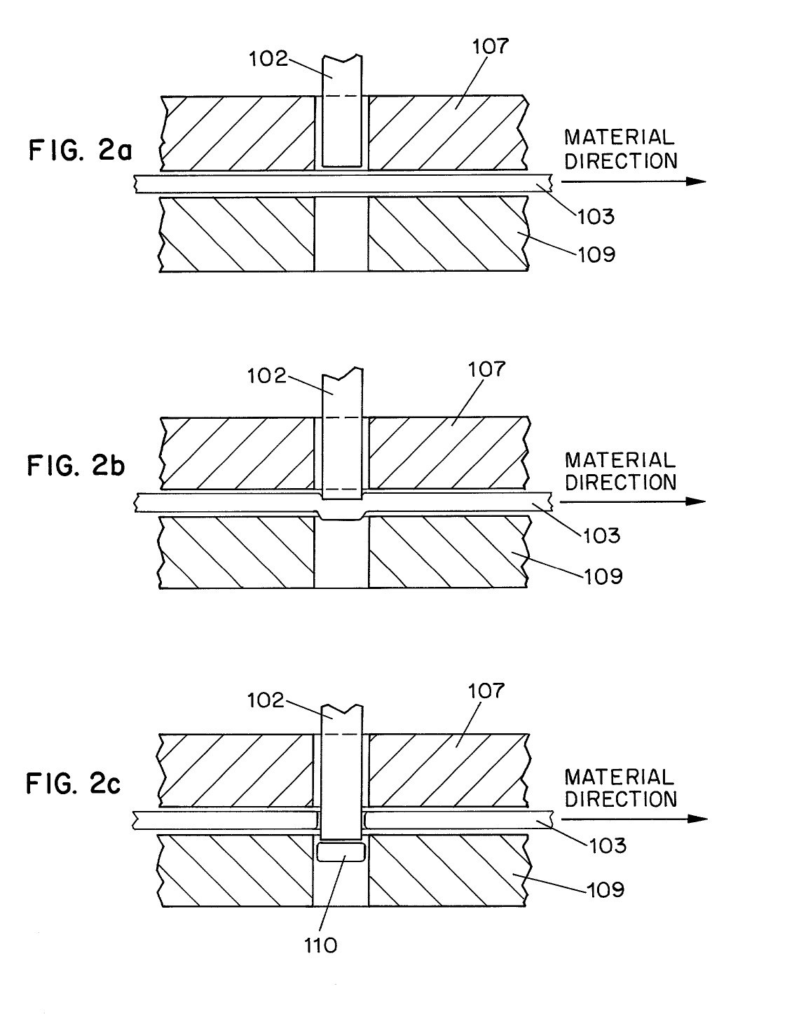

### DETAILED DESCRIPTION OF THE INVENTION

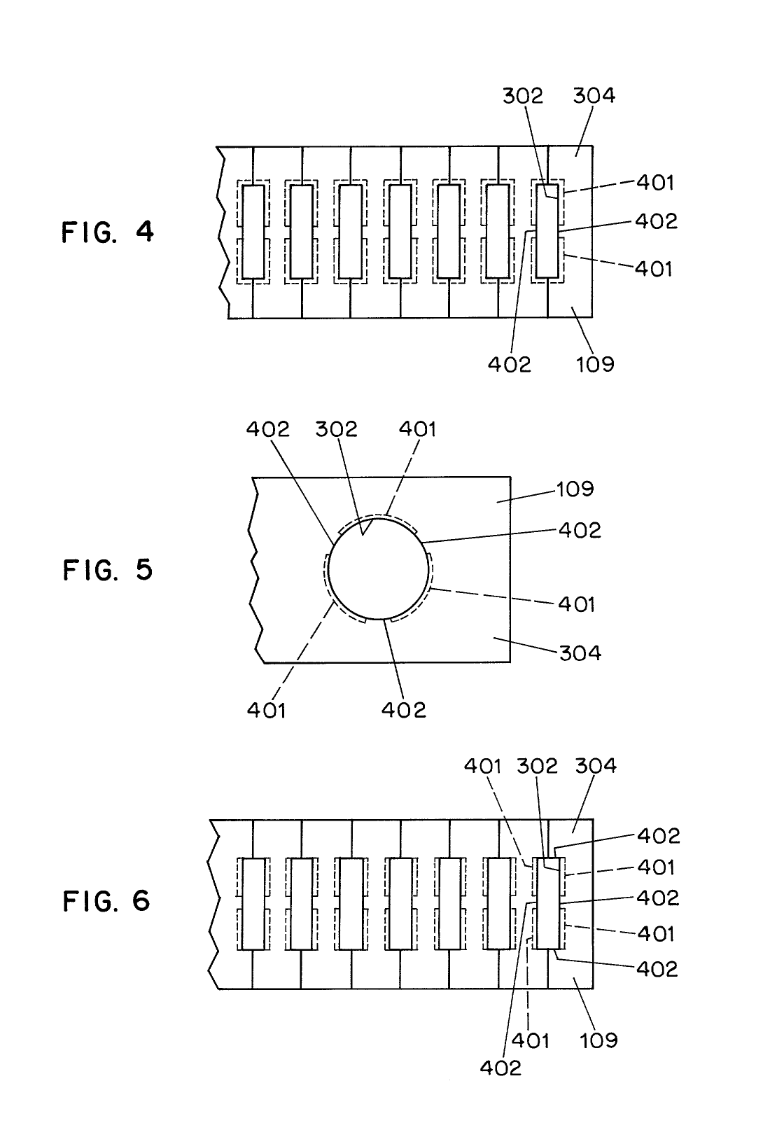

The proposed invention involves an alternative stamp die. An embodiment of the stamp die according to the invention is illustrated in FIG. 4.

The alternative die according to the invention provides certain areas of the die that do not have taper. Not only does this solution provide for reduced slug pulling during the blanking process, it can also extend die life.

The solution prevents slug pulling by providing sufficient lateral pressure for slug retention throughout the die life of the tool. The solution also provides sufficient taper in order to avoid packing by allowing free passage of the slug through the die. By providing taper in certain areas and no taper in others, the alternative press die according to the invention allows the slug to continuously contact portions of the die wall throughout the life of the die, resulting in improved slug retention characteristics.

FIGS. 4, 5 and 6 show several exemplary embodiments of the alternative stamp die 109 according to the invention. The stamp die 109 is provided with an aperture 111 in the shape of the desired configuration of the slug 110 to be produced. The stamp die 109 can be formed of a single piece having an aperture 111 or of multiple pieces the form the configuration of the desired aperture 111 when joined. Similarly, the stamp die 109 can be formed having a plurality of apertures 111 along a cutting edge side 304 of the die 109.

The aperture 111, as shown in FIG. 4, is defined by the cutting edge 302 on a cutting edge side 304 of the stamp die 109. The cutting edge 302 of the stamp die 109 is in turn comprised of a side of at least one tapered area 401 and a side of at least one non-tapered area 402. The tapered area 401 and non-tapered area 402 extend from the cutting edge side 304 of the die 109 to the exit side 305 of the die 109. As shown in FIG. 4, the non-tapered areas 402 can be provided in pairs and can be disposed substantially opposite each other along the perimeter of the aperture 111 in order to provide effectively cooperating lateral forces that counteract the forces that contribute to slug pulling. However, it can be appreciated that different configurations are possible depending on the configuration of the piece to be produced. For example, in FIG. 5, a circular slug 110 can be produced by a circular aperture 111 having a cutting edge 302 comprised of tapered portions 401 and non-tapered portions 402. The non-tapered portions need not be provided substantially opposite one another in order to provide cooperating forces which counteract the slug pulling forces.

The size of the non-tapered areas 402 relative to the tapered areas 401 depend on a number of factors including the thickness of the material 103 being stamped. The non-tapered areas 402 are provided with as much area as avoids packing while still maintaining sufficient lateral force to counteract the slug pulling forces. Generally, the thicker the strip material 103, the more prone are the slugs 111 to packing and therefore the die 109 can accommodate relatively less non-tapered area 402. In contrast, the thinner the strip material 103, more non-tapered area 402 is provided to provide greater contact with the slug to counteract the slug pulling forces.

For example, a die 109 with a rectangular aperture 111, such as shown in FIGS. 4 and 6, can have dimensions of 0.080 inches in length by 0.035 inches in width and can have a depth of 0.750 inches. Strip materials 103 that can be accommodated by such a die 109 typically have a thickness of 0.006 inches to 0.010 inches. Accordingly, for a stamp die 109 to process relatively thicker strip material 103, the stamp die 109 can have one pair of non-tapered areas 402, as shown by FIG. 4a. The non-tapered areas can each be 0.020 inches in length and can be disposed at a mid-point along each of the longer sides of the aperture 111.

For a stamp die 109 provided for processing relatively thinner strip material 103, the stamp die 109 can be provided with relatively more non-tapered area 402. Such a stamp die 109 is shown in FIG. 6 which can have two pairs of non-tapered areas 402, each pair disposed on a side of the aperture 111. Each non-tapered area 402 of one pair of non-tapered areas 402 can be disposed on each of the longer sides of the aperture ill, each area having a length of 0.020 inches along the cutting edge 302. The second pair of non-tapered areas can be disposed on the shorter sides of the aperture and each area can have a length of 0.035 inches, which is equal to the width of the aperture.

Although the invention has been described here by reference to specific embodiments thereof, such embodiments are susceptible of variation and modification without departing from the spirit and scope of the provided claims.

What is claimed is:

1. A stamp die for a stamp press having
at least one cutting portion on a cutting side of the stamp die, whereby the at least one cutting portion has a tapered cutting portion and a non-tapered cutting portion, and defines at least a partial cutting aperture;
at least a partial exit aperture on an exit side of the stamp die and having a tapered exit portion and a non-tapered exit portion;
at least one tapered area on a cavity side of the stamp die extending from the tapered cutting portion to the corresponding tapered exit portion whereby the size of the corresponding tapered partial cutting aperture is less than the corresponding tapered partial exit aperture; and
at least one non-tapered area on the cavity side of the stamp die extending from the non-tapered cutting portion to the corresponding non-tapered exit portion, whereby the size of the corresponding non-tapered partial cutting aperture is the same as the size of the corresponding non-tapered partial exit aperture.

2. The stamp die according to claim 1, wherein
the cutting portion forms a complete cutting aperture through the stamp die to a complete exit aperture, whereby the complete cutting aperture and the complete exit aperture cooperate to form a cavity.

3. The stamp die according to claim 1, wherein
the size of the tapered cutting portion is greater than the size of the non-tapered cutting portion.

4. The stamp die according to claim 2, wherein
the complete cutting aperture forms substantially a circle.

5. The stamp die according to claim 2, wherein
the complete cutting aperture forms a quadrilateral.
